(19) United States
(12) Patent Application Publication
(10) Pub. No.: US 2011/0117780 A1
(43) Pub. Date: May 19, 2011

(54) WATERPROOF CONNECTOR

(75) Inventor: Keiko Ishida, Shizuoka (JP)

(73) Assignee: YAZAKI CORPORATION, Tokyo (JP)

(21) Appl. No.: 13/003,890

(22) PCT Filed: Jul. 14, 2009
(86) PCT No.: PCT/JP2009/062763

§ 371 Date: Jan. 13, 2011

(30) Foreign Application Priority Data
Jul. 15, 2008 (JP) 2008-183880

(51) Int. Cl. H01R 13/52

(52) U.S. Cl. 439/589

(57) ABSTRACT

There is provided a waterproof connector including a plurality of terminals (1) from which stabilizers (3) for preventing reverse-insertion project, a connector housing (10) having terminal containing chambers (11) and a seal mount (12), and a mat seal (20) made of an elastic material, having through-holes (23) into which the respective terminals and electric wires can be fitted, fitted to the seal mount of the connector housing before the terminals are inserted into the terminal containing chambers, and making close contact with the outer peripheries of the electric wires to waterproof between the connector housing and the electric wires. The inner peripheral surface of each through-hole of the mat seal (20) has, at the first half thereof in the direction in which the terminal and the electric wire are press-fitted, an electric wire seal part (25) and also has, at the last half thereof, a reverse-insertion prevention part (24).

### TECHNICAL FIELD

The present invention relates to a waterproof connector having a function of preventing a reverse-insertion of a terminal.

### BACKGROUND ART

Conventionally, it is known, as a water proof connector having a function of preventing a reverse-insertion of a terminal, that the water proof connector includes a plurality of quadrangular terminals 101, a connector housing 110 for containing the terminals 101 therein, a mat seal 120 mounted on a rear side of the connector housing 110, and a rear holder 130 disposed on a rear side of the mat seal 120, as shown in FIG. 4 (see Patent Literature 1, for example).

The terminal 101 is configured in that a stabilizer 103 for reverse-insertion prevention is projected from an outer periphery part of a rectangular prism-shaped box 102 and an electric wire W is crimped at a rear side of the box 102.

The connector housing 110 includes a plurality of terminal containing chambers 111 into which the respective terminals 101 attached to ends of the respective electric wires W can be inserted from rear ends of the terminal containing chamber 111, and also includes a seal mount 112 into which the mat seal 120 is fitted at a rear side of the connector housing 110.

In the mat seal 120, a plurality of through holes 123 into which the respective terminals 101 and the respective electric wires can be fitted are formed in a thick plate 121 which is made of an elastic material such as a rubber. The mat seal 120 is fitted onto the seal mount 112 of the connector housing 110 before inserting the terminals 101 into the respective terminal containing chambers 111. Then, the terminals 101 are inserted into the terminal containing chambers 111 through the through holes 123 from the rear side. Thus, the mat seal 120 makes close contact with the outer peripheries of the electric wires W extending in a rear of the respective terminals 101, and functions as a waterproof between the electric wires W and the connector housing 110.

The rear holder 130 is mounted on and locked to the connector housing 110 from a rear side of the mat seal 120 to function to prevent the mat seal 120 from being dropped out and to have a function of reverse-insertion prevention of the terminals 101.

In the rear holder 130 are formed a plurality of prism-shaped through holes 133 into which the respective terminals 101 and the electric wires are inserted, in a plate 131 contacting the back face of the mat seal 120. In order to achieve the function of the reverse-insertion prevention, a reverse-insertion prevention part 136 is provided at a periphery of each of the through holes 133, for preventing a reverse-insertion of the terminal 101 by allowing a passage of the stabilizer 103 when the terminal 101 is to be inserted with a regular direction and by blocking the passage of the stabilizer 103 when the terminal 101 is to be inserted with an irregular direction. The reverse-insertion prevention part 136 is formed of a groove through which the stabilizer 103 is inserted when inserting the terminal 101 with a regular direction and a non-groove part with which the stabilizer 103 interferes.

When assembling the water proof connector, first, the mat seal 120 is fitted onto the seal mount 112 of the connector housing 110. Next, the rear holder 130 is mounted on and locked to the connector housing 110 from the rear side of the mat seal 120. Accordingly, the fall out of the mat seal 120 can be prevented. Then, the terminals 101 attached to the end of the electric wires are passed through the through holes 133 of the rear holder 130 into the respective terminal containing chambers 111 of the connector housing 110, and the terminals 101 are held inside the terminal containing chambers 111.

In this case, if the position of the stabilizer 103 of the terminal 101 is matched with the groove of the reverse-insertion prevention part 136, it is regarded as a regular direction, and the terminal 101 can be fully inserted into the terminal containing chamber 111 of the connector housing 110 through the through hole 133 of the rear holder 130. On the other hand, when the terminal 101 is to be inserted in a direction where the position of the stabilizer 103 is not matched with the groove of the reverse-insertion prevention part 136, the stabilizer 103 interferes with the rear holder 130 and the terminal 101 cannot be inserted more, thereby to prevent the reverse-insertion of the terminal 101.

Then, when the terminals 101 are fully inserted into the terminal containing chambers 111, the inner peripheries of the through holes 123 of the mat seal 120 make close contact with the outer peripheries of the electric wires extending in a rear side of the terminals 101. Thus, the mat seal 120 waterproofs between the electric wire and the connector housing 110.

### CITATION LIST

### Patent Literature

Patent Literature 1: JP-A-2000-82530

### SUMMARY OF INVENTION

### Technical Problem

Since the conventional waterproof connector forces the rear holder 130 to have a function of reverse-insertion prevention, it is essential to provide the rear holder 130 having the reverse-insertion prevention part 136 in addition to providing the mat seal. In this case, in order to give the function of the reverse-insertion prevention to the rear holder 130, it is necessary to form numbers of through holes 133 corresponding to a number of the terminals 101. Further, the grooves as reverse-insertion prevention parts 136 must be formed in the respective through holes 133. As a result, the structure of the waterproof connector becomes complicated, and the component cost increases.

In consideration with the above circumstance, an object of the present invention is to provide a waterproof connector having a function of a reverse-insertion prevention of a terminal, which adopts a simple structure by which the component cost can be reduced.

### Solution to Problem

A waterproof connector according to an aspect of the invention includes: a plurality of terminals to be attached to electric wires, each of the terminals having a stabilizer for reverse-insertion prevention projected from an outer periphery of the terminal; a connector housing including a plurality of terminal containing chambers for inserting therein the plurality of terminals from one end of the terminal containing chambers, respectively, and a seal mount provided at a side of the one end of the terminal containing chambers; an elastic mat seal including a plurality of through holes into which the respective terminals and the respective electric wires can be fitted, the elastic mat seal being fitted to the seal mount before the terminals are inserted into the respective terminal containing chambers, and making close contact with the outer peripheries of the electric wires to waterproof between the electric wires and the connector housing; and a reverse-insertion prevention part provided at each of the through holes, for preventing a reverse-insertion of the terminals by allowing a passage of the stabilizer when the terminal is to be inserted with a regular direction and by blocking the passage of the stabilizer when the terminal is to be inserted with an irregular direction.

It may be configured in that an electric wire seal part is provided to make contact with the outer periphery of the electric wire at a side of the inner periphery of the through hole where the electric wire seal part faces the terminal containing chamber of the connector housing in a press-fitting direction of the terminal, and the reverse-insertion prevention part is provided at a position opposite to the electric seal part in the press-fitting direction.

It may be configured in that a groove is provided at one part in a circumferential direction of the inner periphery of the through hole to allow the passage of the stabilizer.

It may be configured in that a guide face is provided at least one of on an end wall of the groove and on a front end of the stabilizer hitting against the end wall to smooth the passage of the stabilizer.

### Advantageous Effects of Invention

According to the above-mentioned configuration, since the part which prevents the reverse-insertion of the terminal (the reverse-insertion prevention part) is provided in the mat seal itself which makes close contact with an waterproofs the outer peripheries of the respective electric wires, it becomes unnecessary to force a rear holder to have a function of reverse-insertion prevention of the terminals. Alternatively, even in the case where a rear holder is used, it is unnecessary to force the rear holder to have a function of the reverse-insertion prevention of the terminal. Accordingly, the rear holder only has to have a simple frame structure to prevent the dropout of the mat seal. Therefore, the component cost can be reduced. Especially, when the rear holder is omitted, it is possible to achieve not only the cost reduction by reducing the number of components, but also the improvement of the assembly workability by reducing the worker-hour of assembling the components.

Further, even if the stabilizers exist on the terminals, as far as the terminals are inserted with the regular direction, the terminals can be smoothly inserted into the terminal containing chambers of the connector housing without damaging the mat seal by the stabilizers.

### BRIEF DESCRIPTION OF DRAWINGS

FIG. 1 is an exploded perspective view of a waterproof connector according to an embodiment of the invention.

FIG. 2 is a structural diagram of a mat seal of the waterproof connector according to the embodiment, in which (a) is a cross-sectional view of the mat seal, (b) is a perspective view of a front side of the mat seal, and (c) is a perspective view of a rear side of the mat seal.

FIG. 3 is a cross-sectional view of the waterproof connector in an assembled state according to the embodiment.

FIG. 4 is an exploded perspective view of a conventional waterproof connector.

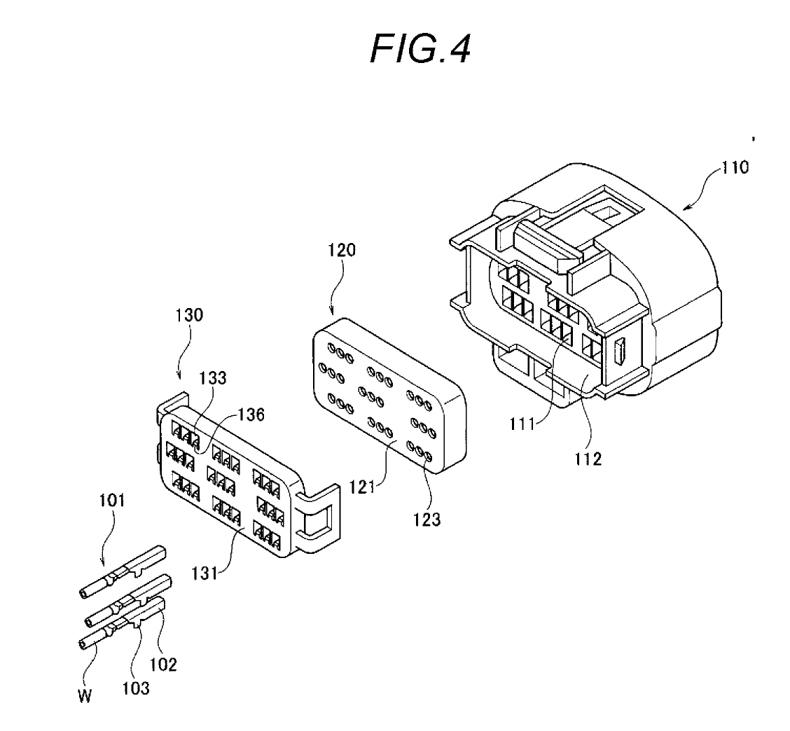

### DESCRIPTION OF EMBODIMENTS

A description is made of an embodiment of the invention with reference to the accompanying drawings.

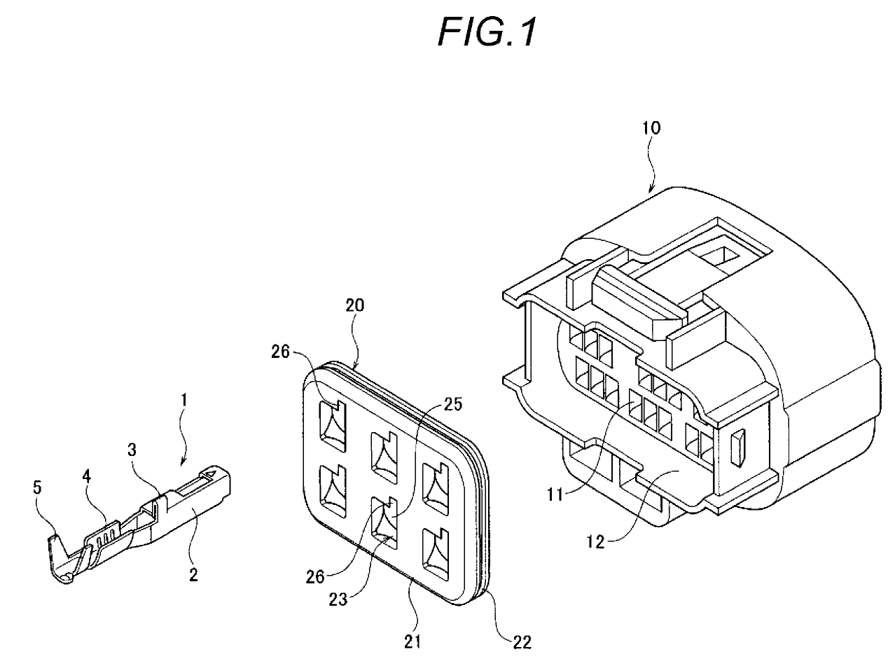

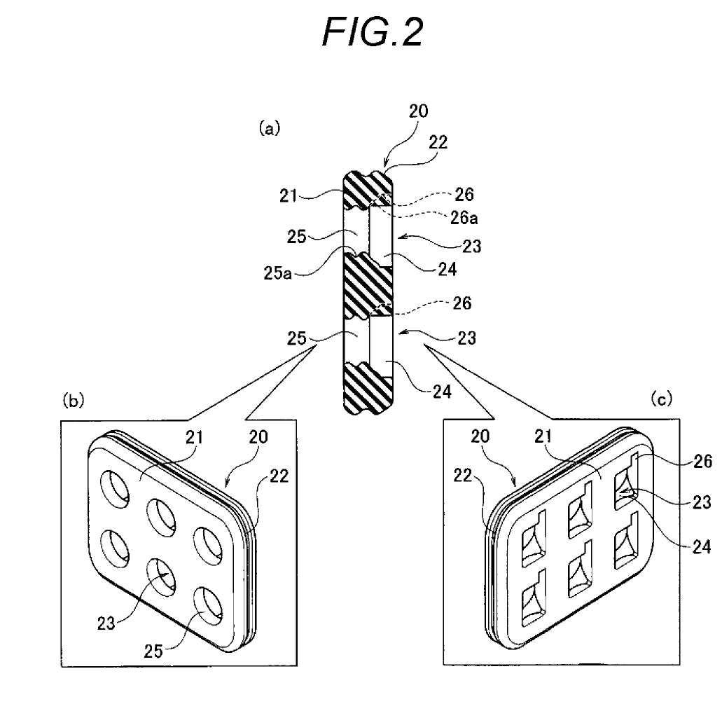

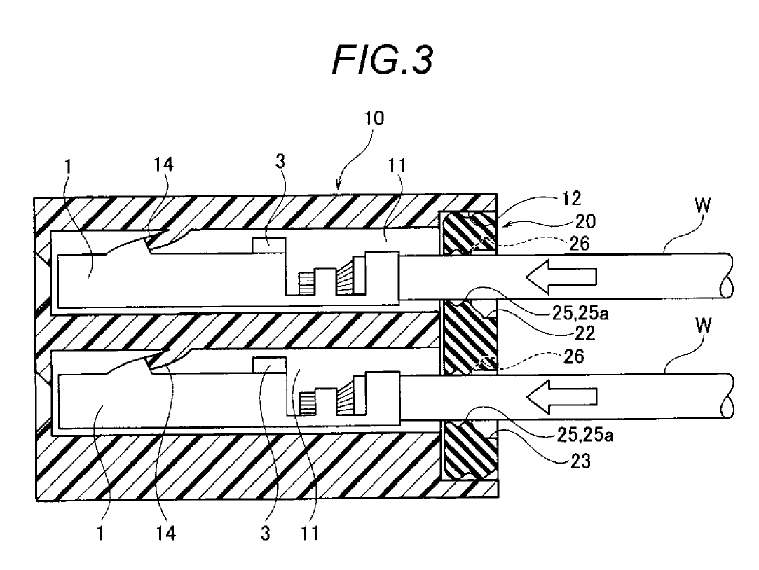

FIG. 1 is an exploded perspective view of a waterproof connector according to the embodiment. FIG. 2 is a structural diagram of a mat seal of the waterproof connector according to the embodiment, in which (a) is a cross-sectional view of the mat seal, (b) is a perspective view of a front side of the mat seal, and (c) is a perspective view of a rear side of the mat seal. FIG. 3 is a cross-sectional view of the waterproof connector in an assembled state.

The waterproof connector includes a plurality of terminals 1, each terminal 1 having a stabilizer 3 for reverse-insertion prevention projected from an outer periphery of the terminal 1, a plurality of terminal containing chambers 11 into which the respective terminals 1 attached to ends of the respective electric wires W can be inserted from rear ends of the terminal containing chamber 11. The waterproof connector also includes a connector housing 10 having a seal mount 12 provided at a rear side of the connector housing 10 and a mat seal 20 to be fitted onto the seal mount 12 of the connector housing 10.

The mat seal 20 includes a plurality of through holes 23 into which the respective terminals 1 and electric wires W can be press-fitted. The mat seal 20 is fitted onto the seal mount 12 of the connector housing 10 before inserting the terminals 1 into the respective terminal containing chambers 11. Then, the terminals 1 are inserted into the terminal containing chambers 11 through the through holes 23 from the rear side. Thus, the mat seal 20 makes close contact with the outer peripheries of the electric wires W extending in a rear of the respective terminals 1, and functions as a waterproof between the electric wires W and the connector housing 10.

The terminal 1 is configured in that a stabilizer 3 for reverse-insertion prevention is projected from an outer periphery part of a rectangular prism-shaped box 2. At the rear part of the box 2 are provided a conductor-crimping part 4 and a sheath-crimping part 5 to crimp the electric wire W thereon.

The mat seal 20 is configured so that the plurality of through holes 23 into which the respective terminals 1 and electric wires W can be fitted are formed in a thick plate 21 which is made of an elastic material such as a rubber to correspond to the respective terminal containing chambers 11. Since the mat seal 20 is provided with a reverse-insertion prevention function of the terminal, providing a rear holder is omitted.

That is, in each of the through holes 23 passing toward a thickness direction of the mat seal 20, the inner peripheral surface of the through hole 23 has, at the first half thereof in the direction in which the terminal 1 and the electric wire W are press-fitted, an electric wire seal part 25 which makes contact with and waterproofs the outer periphery of the electric wire W. The inner peripheral surface of the through hole 23 also has, at the last half thereof in the direction in which the terminal 1 and the electric wire W are press-fitted, a reverse-insertion prevention part 24 for preventing a reverse-insertion of the terminal 1 by allowing a passage of the stabilizer 3 when the terminal 1 is to be inserted with a regular direction and by blocking the passage of the stabilizer 3 when the terminal 1 is to be inserted with an irregular direction.

In the electric wire seal part 25, an inner peripheral lip 25a is provided to make close contact with the outer periphery of the sheath of the electric wire W. In the reverse-insertion prevention part 24, a groove 26 is formed at one part in a circumferential direction of the inner periphery of the through hole 23 to allow the passage of the stabilizer 3. That is, the reverse-insertion prevention part 24 is formed of the groove 26 through which the stabilizer 3 is inserted when inserting the terminal 1 with a regular direction and a non-groove part with which the stabilizer 3 interferes.

In an end wall inside the groove 26, a guide face (an inclined face) 26a is provided to smooth the passage of the stabilizer 3. The guide face for smoothing the passage of the stabilizer 3 may be provided as well on a front end of the stabilizer 3 hitting against the end wall inside the groove 26. The guide faces may be also provided both on a side of the groove 26 and on a side of the stabilizer 3.

In the outer periphery of the mat seal 20, an outer peripheral lip 22 is provided to make contact with and surely waterproofs the connector housing 10 when the mat seal 20 is fitted onto the seal mount 12 of the connector housing 10.

When assembling the water proof connector, first, the mat seal 20 is fitted onto the seal mount 12 of the connector housing 10. Then, the terminals 1 attached to the end of the electric wires W are passed through the through holes 23 of the mat seal 20 into the respective terminal containing chambers 11 of the connector housing 10, and the terminals 1 are fixed to be prevented from dropped out by a lance 14 inside the terminal containing chambers 11.

When the terminal 1 is inserted, if the position of the stabilizer 3 of the terminal 1 is matched with the groove 26 of the reverse-insertion prevention part 24 of the mat seal 20, it is regarded as a regular direction, and the terminal 1 can be fully inserted into the terminal containing chamber 11 of the connector housing 10 through the through hole 23 of the mat seal 20. On the other hand, when the terminal 1 is to be inserted in a direction where the position of the stabilizer 3 is not matched with the groove 26 of the reverse-insertion prevention part 24, the stabilizer 3 interferes with a wall of the mat seal 20 and the terminal 1 cannot be inserted more, thereby to prevent the reverse-insertion of the terminal 1.

Then, when the terminals 1 are fully inserted into the terminal containing chambers 11, the electric wire seal parts 25 of the through holes 23 of the mat seal 20 make close contact with the outer peripheries of the sheaths of the electric wires W extending in a rear side of the terminals 1. Thus, the mat seal 20 waterproofs between the electric wire W and the connector housing 10.

As mentioned above, according to the waterproof connector of the embodiment, since the part which prevents the reverse-insertion of the terminal 1 (the reverse-insertion prevention part 24) is provided in the mat seal 20 itself which makes close contact with an waterproofs the outer peripheries of the respective electric wires W, it becomes unnecessary to force a rear holder to have a function of reverse-insertion prevention of the terminals 1 as required in the conventional way. Therefore, it is possible to mount the mat seal in a single piece on the connector housing 10 with the rear holder omitted. Thus, the cost can be reduced by reducing the number of components, and the assembly workability can be improved by reducing the worker-hour of assembling the components.

Further, the guide faces 26a are provided on the end wall of the grooves 36 of the reverse-insertion prevention part 24. Thus, even if the stabilizers 3 exist on the terminals 1, as far as the terminals 1 are inserted with the regular direction, the terminals 1 can be smoothly inserted into the terminal containing chambers 11 of the connector housing 10 without damaging the mat seal 20 by the stabilizers 3.

In addition, simply-structured rear holder may be mounted on a rear side of the connector housing 10 in order to avoid the dropout of the mat seal 20 or to apply the pressure to the mat seal 20 for the purpose of increasing the contact property. Even in the case, it is unnecessary to force the rear holder to have a function of the reverse-insertion prevention of the terminal. Accordingly, the rear holder only has to have a simple frame structure to prevent the dropout of the mat seal 20, and it does not take a cost for manufacturing the component. By forcing the rear holder to have a function of the reverse-insertion prevention, by necessity, in addition to the reverse-insertion prevention part 24 of the mat seal 20, it is possible to force the waterproof connector to have a double function of the reverse-insertion prevention.

### INDUSTRIAL APPLICABILITY

According to the present invention, since the reverse-insertion prevention part is provided in the mat seal, the invention can provide a waterproof connector adopting a structure by which the component cost can be reduced

### REFERENCE SIGNS LIST

1: Terminal
3: Stabilizer
10: Connector housing
11: Terminal containing chamber
12: Seal mount
20: Mat seal
23: Through-hole
24: Reverse-insertion prevention part
25: Electric wire seal part
26: Groove
26a: Guide face
W: Electric wire

1: A waterproof connector, comprising:
a plurality of terminals to be attached to electric wires, each of the terminals having a stabilizer for reverse-insertion prevention projected from an outer periphery of the terminal;
a connector housing including a plurality of terminal containing chambers for inserting therein the plurality of terminals from one end of the terminal containing chambers, respectively, and a seal mount provided at a side of the one end of the terminal containing chambers;
an elastic mat seal including a plurality of through holes into which the respective terminals and the respective electric wires can be fitted, the elastic mat seal being fitted to the seal mount before the terminals are inserted into the respective terminal containing chambers, and making close contact with the outer peripheries of the electric wires to waterproof between the electric wires and the connector housing; and
a reverse-insertion prevention part provided at each of the through holes, for preventing a reverse-insertion of the terminals by allowing a passage of the stabilizer when the terminal is to be inserted with a regular direction and by blocking the passage of the stabilizer when the terminal is to be inserted with an irregular direction.

2: The waterproof connector according to claim 1, wherein
an electric wire seal part is provided to make contact with the outer periphery of the electric wire at a side of the inner periphery of the through hole where the electric wire seal part faces the terminal containing chamber of the connector housing in a press-fitting direction of the terminal, and
the reverse-insertion prevention part is provided at a position opposite to the electric seal part in the press-fitting direction.

3: The waterproof connector according to claim 1, wherein
a groove is provided at one part in a circumferential direction of the inner periphery of the through hole to allow the passage of the stabilizer.

4: The waterproof connector according to claim 1, wherein
a guide face is provided at least one of on an end wall of the groove and on a front end of the stabilizer hitting against the end wall to smooth the passage of the stabilizer.
